(19) United States
(12) Patent Application Publication
(10) Pub. No.: US 2013/0049668 A1
(43) Pub. Date: Feb. 28, 2013

(54) Power Source to Remote Drive Interconnection Scheme

(71) Applicants: George B. Yundt, Andover, MA (US); Robert Pearce, Bristol (GB)

(72) Inventors: George B. Yundt, Andover, MA (US); Robert Pearce, Bristol (GB)

(73) Assignee: Kollmorgen Corporation, Radford, VA (US)

(21) Appl. No.: 13/214,500

(22) Filed: Aug. 22, 2011

(51) Int. Cl. H02P 4/00; H02J 1/10

(52) U.S. Cl. 318/558; 307/28

(57) ABSTRACT

A decentralized motor drive arrangement provides high-voltage operational power and low-voltage standby power from a centralized distribution unit to remote motor drives using the same pair of interconnection power wires. The distribution unit includes a low-voltage power source which has one output terminal diode coupled to one of the output terminals of a high-voltage power source to form one output wire of the distribution unit. The other output terminals of the low-voltage and high-voltage power sources are directly coupled to form the other distribution unit outgoing power wire.

### BACKGROUND OF THE INVENTION

Decentralized electronic motor drive arrangements typically include a distribution unit with a central power source and control electronics coupled via a set of power and control wires to a plurality of remote electronic motor drives. The remote electronic drives include power and control electronics to control motors, such as servo motors, and interface electronics, such as for feedback devices, mechanical brakes, network interfaces, diagnostic devices, and the like.

FIG. 1 illustrates a typical decentralized drive arrangement in which a distribution unit 110 is coupled to a plurality of motor drives 150A-150F. The distribution unit 110 includes control electronics (not illustrated) and two internal DC power sources supplied from two, independent, connections 115 and 120 to external power. High-voltage power source 101 typically provides the power used by the remote drive to move the motor and low-voltage power source 102 provides power for the remote drive control electronics. Distribution unit 110 is directly coupled via hybrid cables to each of motor drives 150A and 150D. Motor drives 150A and 150D are respectively coupled via hybrid cables to motor drives 150B and 150E, which are in turn respectively coupled via hybrid cables to motor drives 150C and 150F.

A hybrid interconnection cable comprises, at a minimum, conductors for power and for control. Conventionally, each of the hybrid cables includes six or more wires, at least two control signal wires and four power wires, two of the power wires supply high-voltage power from high-voltage power source 101 and the other two power wires supply low-voltage power from low-voltage power source 102. The connection arrangement of motor drives 150A-150F is commonly referred to as a daisy-chain power arrangement and the daisy-chaining could be from one to an arbitrarily large number of units. Although FIG. 1 shows a distribution unit with two daisy-chain connections, a single daisy chain or more than two daisy-chains could be attached according to the needs of the plant or machine. Distribution unit 110 also includes a pair of network interfaces 130 and 135 for sending control signals and receiving feedback and diagnostic signals used to control and monitor each of the motor drives 150A-150F. Each of the network interfaces is connected to control signal wires of the hybrid cable. Although FIG. 1 shows two network interfaces 130 and 135 only one could be used. Offering more than one network interface is a practical convenience.

FIG. 2 illustrates an example prior art structure of the power sources 101 and 102 of the distribution unit 110 and the power connections to the remote motor drives 150A-150F. Power source 101 converts the incoming AC line power into high-voltage (e.g., 600 volts) direct current and power source 102 converts incoming AC line power into low-voltage (e.g., 42 volts) direct current. Specifically, as illustrated on the left side of distribution unit 110, the low-voltage power source 102 accepts AC line power and converts it to a stepped-down DC voltage power using voltage rectifier 210, smoothing capacitor 215 and isolating DC-DC converter 220. As illustrated on the right side of distribution unit 110, the high-voltage power source 101 receives AC line power and converts it to a high-voltage direct current power using rectifier 225 and smoothing capacitor 230.

FIG. 3 illustrates a conventional motor drive 150, which schematically represents any of the motor drives in FIG. 2. The high-voltage main power, which is supplied via wires 204C and 204D, is provided to amplifier 355, which controls and powers motor 357. Amplifier 355 also provides control signals to control electronics 360. The low-voltage control power, which is supplied via wires 204A and 204B, is provided to internal low-voltage power supply 370, which converts the low-voltage power to a voltage level compatible with the circuits of control electronics 260, such as 15, 5 and 3.3 volts.

There may be times when it is desired to service one or more of motor drives 150A-150F or to service machinery attached to the drives, in which case the high-voltage required to operate the motors can present hazardous conditions for the servicing personnel. Accordingly, when servicing one or more of the motor drives 150A-150F, or the attached machinery, the main AC line feed 115 must be disconnected from the distribution unit 110, this in turn will disconnect the high-voltage power source from remote motor drives 150A-150F. During these times of servicing it is desirable to continue to provide the low-voltage direct current power so that the control electronics are still active. Active control electronics allow the motor drives to operate in a standby state and also to maintain their presence on the network. The use of a low-voltage control power (specifically of isolated Safety Extra Low-voltage type) allows servicing personnel to manually operate the motors, including electrically releasing a motor's mechanical brake if fitted, and to read the motor position and other diagnostic information, without concern for the shock hazard that can be encountered when the high-voltage power for operating the motors is present.

FIG. 6 shows the four possible states of the system arising from the two power inputs 115 and 120 and summarizes the resulting operational states. Typical prior art decentralized drive arrangements needed four power wires from distribution unit 110 to each of the remote motor drives 150A-150F in a daisy-chained manner, two of the wires providing low-voltage direct current power and two of the wires providing high-voltage direct current power, to be able to provide the three useful operational states shown in FIG. 6.

### SUMMARY OF THE INVENTION

To provide high and low-voltage power to motor drives, conventional decentralized drive arrangements employ four power wires. The low-voltage wires, although they transmit relatively little power, can carry significant current and are therefore comparable in wire gauge to the high-voltage wires. Furthermore the low-voltage wires still require thick insulation to ensure isolation from the high-voltage conductors. It has been recognized that when the high-voltage power source provides power, only a small increase in the current supplied to the remote motor drives (i.e. the motors and the associated amplifiers) from the high-voltage rail would be sufficient to operate both the motors and their associated control electronics, if a mechanism can be devised to extract the control electronics power from the high-voltage rail. Thus, with such a mechanism the low-voltage wires are superfluous in that they contribute very little to the power that is transmitted. Additionally, the two wires used for the control power add significantly to the weight, diameter, rigidity and cost of the hybrid cable; they also add two pins to the hybrid connector. These additions lead to significant increases in cabling costs.

In view of these and other deficiencies of conventional decentralized drive arrangements, exemplary embodiments of the present invention provide low-voltage and high-voltage power in a decentralized drive arrangement with only two power wires from the distribution unit to any particular remote motor drive, i.e., two power wires from the distribution unit to the first remote motor drive in the daisy chain, two power wires from the first remote motor drive to the next remote motor drive in the daisy chain, etc. This can be achieved by coupling a low-voltage power source to the high-voltage power source and to one wire of the two power wires via a diode. In this arrangement, the diode conducts whenever the output voltage of the high-voltage power source is less that the output voltage of the low-voltage power source, such as when the high-voltage power source is off

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a block diagram of a conventional decentralized drive arrangement;

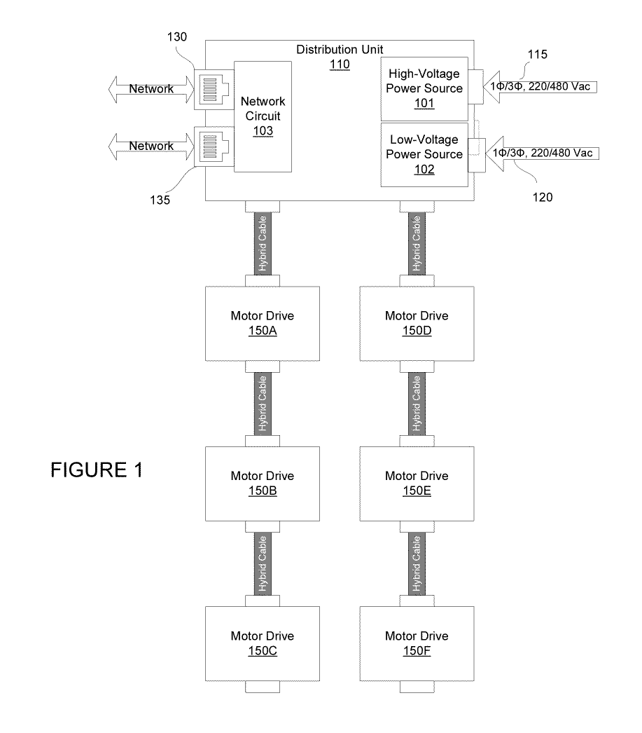

FIG. 2 is a block diagram of a distribution unit of a conventional decentralized drive arrangement;

FIG. 3 is a block diagram of the conventional motor drive;

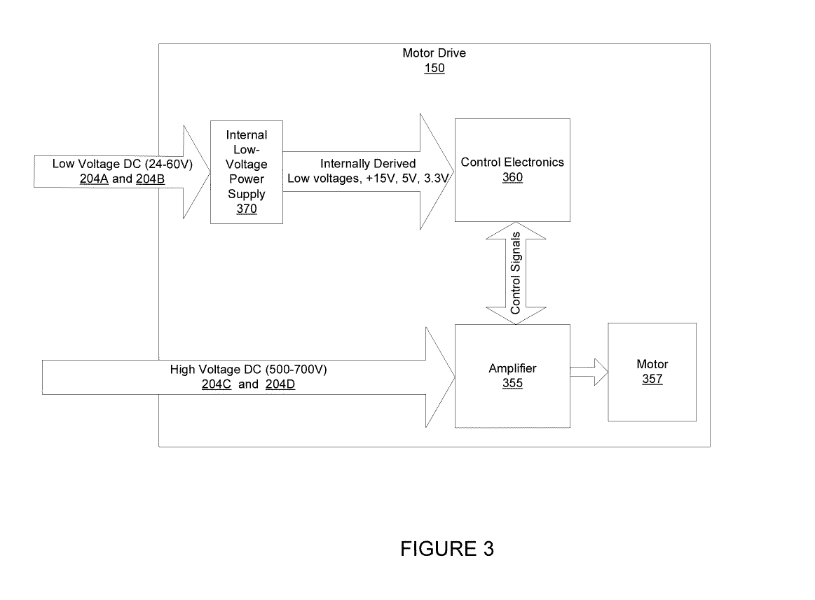

FIG. 4 is a block diagram of a distribution unit for a decentralized drive arrangement in accordance with exemplary embodiments of the present invention;

FIG. 5 is a block diagram of a motor drive for a decentralized drive arrangement in accordance with exemplary embodiments of the present invention; and

FIG. 6 is a Karnaugh map showing the state of the decentralized drive system and the machine that it automates as determined by state of the high-voltage power source and the low-voltage power source, this diagram applies equally to the prior art and to the present invention.

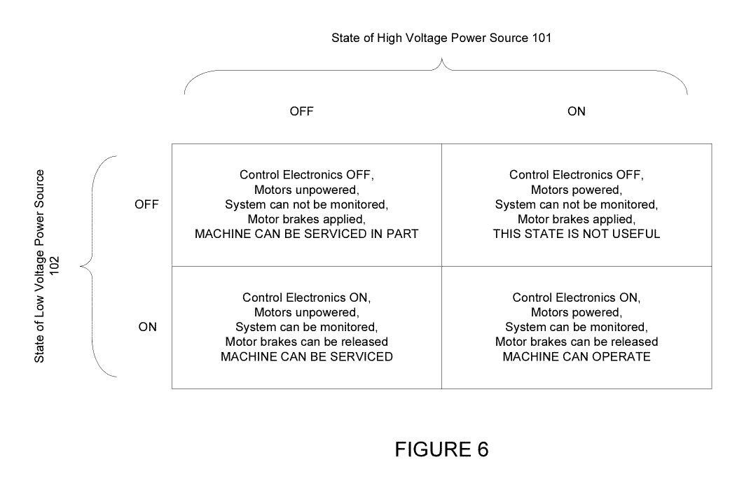

### DETAILED DESCRIPTION OF THE PREFERRED EMBODIMENTS

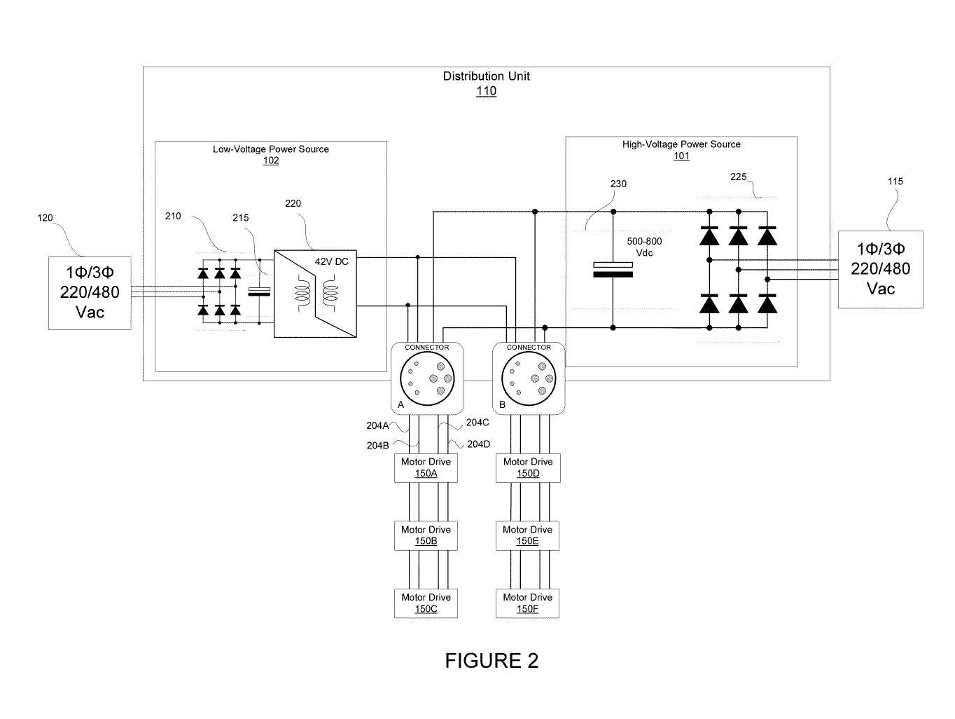

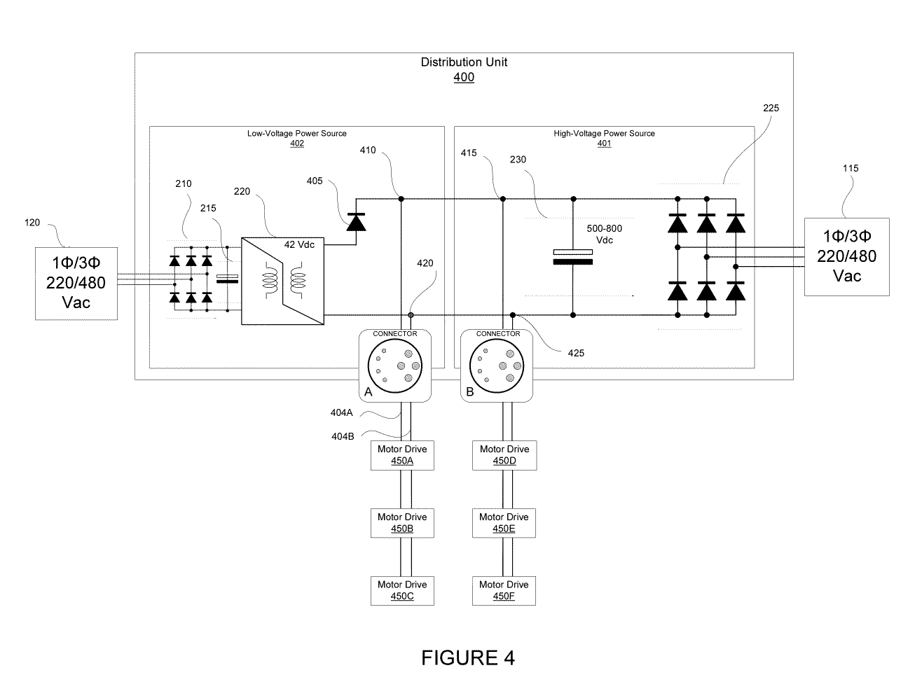

FIG. 4 is a block diagram of a distribution unit for a decentralized drive arrangement in accordance with exemplary embodiments of the present invention. Similar to the arrangement of FIG. 2, the distribution unit of FIG. 4 includes a low-voltage power source that receives AC line voltage and converts the power to a stepped-down DC voltage using voltage rectifier 210, smoothing capacitor 215 and isolating DC-DC converter 220. The distribution unit also includes a high-voltage power source 401 that receives AC line voltage and converts it to a high-voltage direct current power using rectifier 225 and smoothing capacitor 230. The low-voltage power source produces an isolated safety extra low-voltage, for example, a voltage of approximately 42 volts direct current. The high-voltage power source can produce, for example, a voltage of approximately 600 volts direct current. It should be recognized that the particular voltage levels produced by the high- and low-voltage power sources can be implementation-specific and the use of different voltage levels from the disclosed levels does not affect the operation of the invention. It should also be recognized that power sources, such as element 120 in FIGS. 2 and 4, could be from a DC power source, in which case low-voltage power source 102 or 402 would have a DC-DC converter instead of the illustrated AC-DC converter.

In distribution unit 400, the isolating DC-DC converter 220 of low-voltage power source 402 is coupled to the same power lines as the output of smoothing capacitor 230 of high-voltage power source 401. Specifically, diode 405 couples one of the outputs of isolating DC-DC converter 220 to one of the two outgoing power wires via nodes 410 and 415, to which one of the terminals of smoothing capacitor 230 is coupled. The other output of isolating DC-DC converter 220 is coupled to the other of the two outgoing power wires at nodes 420 and 425, to which the other terminal of smoothing capacitor 230 is coupled. Diode 405 sources current from the low-voltage power source 402 to the distribution cables 404A and 404B only when high-voltage power source 401 is off

Accordingly, diode 405 conducts whenever the output voltage of high-voltage power source 401 is less that the output voltage of low-voltage power source 402. In this state low-voltage power is supplied to motor 450A-450F and the associated control electronics can operate but the motors cannot. This state allows servicing personnel to work on the devices without being exposed to the hazards of high-voltage power or un-intended high power motion from the motor.

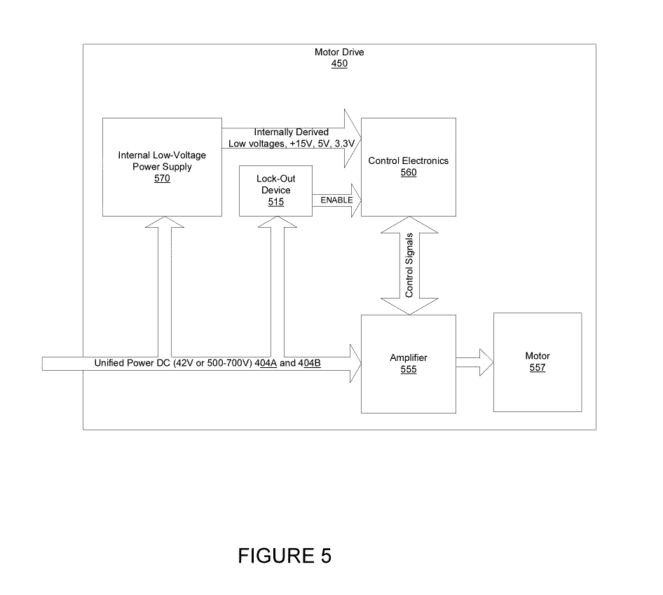

FIG. 5 is a block diagram of a motor drive for a decentralized drive arrangement in accordance with exemplary embodiments of the present invention. The motor drive 450 includes a power supply 570 coupled to the two wires that can carry both the high-voltage and low-voltage power. Power supply 570 can include a DC/DC converter to step-down the voltage of the incoming DC power to an appropriate voltage level for the other elements of the motor drive. Accordingly, power supply 570 provides DC power to control electronics 560 (e.g., feedback devices, mechanical brakes, network interfaces, diagnostic devices, and the like). Amplifier 555, which powers the motor 557, is powered directly by the unified power rails 404A and 404B. When high-voltage power is supplied over the two incoming power wires, both motor 557 and control electronics 550 are operational. When low-voltage power is supplied over the two incoming power wires, only the control electronics 550 should be operational. Accordingly, lockout device 515 is arranged to prevent motor 557 from operating when only low-voltage power is supplied over the two incoming power wires. Lockout device 515 monitors the incoming power wires 404A and 404B and emits an enable signal to the control electronics 560 only when the incoming voltage is higher than can be supplied by the low-voltage source 402, that is lockout device 515 emits an enable signal to the control electronics 560 only when the high-voltage power source 401 is active. Although not illustrated in FIG. 5, it should be recognized that motor drive 450 is arranged to pass the power from the two incoming power wires to a next motor drive in a daisy chain of motor drives.

It should be recognized that the terms low-voltage power and high-voltage power are intended to be relative terms with respect to each other and that the low-voltage power is a voltage level that does not present a serious hazard to someone who contacts the low-voltage power, such as servicing personnel. Additionally, the high-voltage power is dimensioned so that it is sufficient to power both the motor and the control electronics of the devices and the low-voltage power is dimensioned so that it is sufficient to power the control electronics of the devices.

The powering arrangement of the present invention can also be employed in connection with the safe torque off (STO) technique disclosed in U.S. patent application Ser. No. ______ (Attorney Docket No. 105664.63509US), entitled “Safe Torque Off Over Network Wiring”, filed on even date herewith, the entire disclosure of which is herein expressly incorporated by reference.

The power source of the present invention provides a number of advantages over conventional power sources. Specifically, the cabling required to source power from the distribution unit to the motor drives and between the motor drives is smaller, cheaper and easier to handle because only two power wires are required to carry both the high and low-voltage power, whereas the conventional power source arrangements required four wires. Furthermore, despite only having two power wires the present invention provides both high-voltage power for operating the motors and low-voltage standby power for control and diagnostic electronics. Additionally, when the high-voltage power is being passed over the two wires the low-voltage power source can be turned-off to reduce the power consumed and the heat generated by the low-voltage power source. Moreover, when the high-voltage power source is being supplied to the two power wires the number of daisy-chained motor drives is not limited by the capacity of the low-voltage power source and the possible length of cable is greatly increased because of the much lower voltage drop in cable resistance.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

What is claimed is:

1. A distribution unit, comprising:
a high-voltage power source;
a low-voltage power source;
a pair of power wires coupling the distribution unit to an external device powered by the distribution unit,
wherein the high-voltage power source is directly coupled to the pair of power wires and the low-voltage power source is directly coupled to one power wire of the pair of power wires and is coupled to the other power wire of the pair of power wires via a diode.

2. The distribution unit of claim 1, wherein the external device is an electronic drive powering a motor and control electronics, the high-voltage power source supplies power to operate the motor and control electronics and the low-voltage power source supplies power to operate only the control electronics.

3. The distribution unit of claim 1, wherein the high-voltage power source receives a single phase or three-phase alternating current and generates high-voltage direct current.

4. The distribution unit of claim 1, wherein the low-voltage power source receives single phase or three-phase alternating current and generates low-voltage direct current.

5. The distribution unit of claim 1, wherein the low-voltage power source receives direct current and generates low-voltage direct current.

6. A system, comprising:
a distribution unit, comprising
a high-voltage power source;
a low-voltage power source;
a pair of power wires coupled to the high-voltage power source and the low-voltage power source, wherein the high-voltage power source is directly coupled to the pair of power wires and the low-voltage power source is directly coupled to one power wire of the pair of power wires and is coupled to the other power wire of the pair of power wires via a diode; and
a first external device coupled to the pair of power wires and powered by the distribution unit.

7. The system of claim 6, further comprising:
a second external device coupled to the first external device, wherein the first external device includes a second pair of power wires that are coupled to the second external device to provide power to the second external device.

8. The system of claim 6, wherein the first external device is an electronic drive with a motor and control electronics, the high-voltage power source sources power to operate the motor and control electronics and the low-voltage power source sources power to operate only the control electronics.

9. The system of claim 8, wherein the first external device includes a lock-out device coupled to the pair of power wires and the control electronics, wherein the lock-out device is arranged to emit an enable signal to the control electronics only when a voltage level on the pair of power wires is more than a voltage level sourced by the low-voltage power source.

10. The system of claim 6, wherein the high-voltage power source receives single phase or three-phase alternating current and generates high-voltage direct current.

11. The system of claim 6, wherein the low-voltage power source receives single phase or three-phase alternating current and generates low-voltage direct current.

12. The system of claim 6, wherein the low-voltage power source receives direct current and generates low-voltage direct current.

13. The system of claim 8, wherein the first external device includes a power supply coupled to the pair of wires that converts high-voltage and low-voltage power into a voltage level compatible with control electronics of the external device.

14. A motor drive, comprising:
an amplifier coupled directly to a pair of incoming power wires carrying a high-voltage power;
a motor coupled to the amplifier;
a low-voltage power supply coupled directly to the incoming pair of power wires; and
control electronics coupled to the low-voltage power supply,
wherein the high voltage power on the incoming pair of power wires is provided to the amplifier without modification and the high voltage power on the incoming pair of power wires is reduced by the low-voltage power supply to a low-voltage power of the control electronics.

15. The motor drive of claim 14, further comprising:
a lock-out device coupled to the pair of incoming power wires and the control electronics, wherein the lock-out device is arranged to emit an enable signal to the control electronics only when a voltage level on the pair of power wires is more than a voltage level sourced by the low-voltage power source.
